(19) United States
(12) Patent Application Publication
(10) Pub. No.: US 2024/0308000 A1
(43) Pub. Date: Sep. 19, 2024

(54) CLADDING PROCESS FOR IN-SITU PIPES INTEGRITY

(71) Applicant: SAUDI ARABIAN OIL COMPANY, Dhahran (SA)

(72) Inventor: Sameeh Issa Batarseh, Dhahran Hills (SA)

(73) Assignee: SAUDI ARABIAN OIL COMPANY, Dhahran (SA)

(21) Appl. No.: 18/183,233

(22) Filed: Mar. 14, 2023

(51) Int. Cl. B23K 26/342; B23K 26/06; B23K 26/14

(52) U.S. Cl. CPC B23K 26/342; B23K 26/0608; B23K 26/14; B23K 2101/10

(57) ABSTRACT

An in-situ cladding method including providing a pipe with a target surface with a defected area. The method also includes lowering an in-situ cladding system into the pipe. The in-situ cladding system includes a dual head laser, with primary and secondary beams, and a wire feeding system. The method also includes lowering the wire feeding system into the pipe, feeding a cladding wire onto the target surface, melting the cladding wire onto the target surface with the primary beam, and blowing gas onto the cladding wire using an internal purging system. The method further includes forcing melting of the cladding wire in a first desired direction to form a first layer, forcing melting of the cladding wire in a second desired direction to form a second layer, switching off the primary beam and switching on the secondary beam, and welding the first and second layers together using the secondary beam.

### BACKGROUND

During downhole operations, pipes, such as downhole casings and tubings, may corrode, rust, or erode, causing defecting. Such defects require replacement, which can be costly in terms of both expense and downtime. In particular, casing and tubing require additional work in comparison to surface pipes, since casing and tubing must be retrieved from the downhole environment in order to be replaced.

Laser cladding is a process by which a thin layer of metal and alloys may be added to a material using laser technology. Such a process forms a new, strong face of the material. Laser cladding may be accomplished, for example, by performing hot wire cladding, as shown in FIGS. 1A and 1B. FIGS. 1A and 1B show an exemplary laser cladding system 100. An exemplary laser cladding system 100 may include a wire feeding system 102 configured to feed a cladding wire 104 onto a target surface 106. A laser beam 108 may be used to melt the cladding wire 104 onto the target surface 106. The wire feeding system 102 and the laser beam 108 may be moved in concert in a desired direction 107, such that the cladding wire 104 is melted onto the target surface 106 in a linear pattern, as shown in FIG. 1B. The wire feeding system 102 may further include an internal purging system 110, which may be configured to purge and cool the target surface 106, as well as remove any debris. The cladding wire 104 may be melted onto the target surface 106 in successive layers until the target surface 106 is completely covered.

The exemplary laser cladding system 100 may be utilized for surface cladding, where cladding is performed on a pipe at a surface location with no space restrictions or geometric restrictions.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to an in-situ cladding method. The method may include providing a pipe with a target surface, where the target surface comprises a defected area, and inserting an in-situ cladding system into the pipe, where the in-situ cladding system comprises a dual head laser and a wire feeding system. The dual head laser may include a primary beam and a secondary beam. The method may also include inserting the wire feeding system into the pipe, feeding a cladding wire onto the target surface, and melting the cladding wire onto the target surface with the primary beam. The method may further include blowing gas onto the cladding wire using an internal purging system integrally formed with the secondary beam, forcing melting of the cladding wire in a first desired direction using the internal purging system to form a first layer, and forcing melting of the cladding wire in a second desired direction using the internal purging system to form a second layer. The method may also include switching off the primary beam and switching on the secondary beam and welding the first layer and the second layer together using the secondary beam.

In another aspect, embodiments disclosed herein relate to an in-situ cladding system. The system may include a wire feeding system configured to feed a cladding wire onto a target surface of a pipe, and a dual head laser aimed at the target surface.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The size and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIGS. 1A and 1B show a conventional laser cladding system.

FIG. 2 shows an in-situ laser cladding system in accordance with one or more embodiments.

FIGS. 3A-3E show a workflow of using an in-situ laser cladding system in accordance with one or more embodiments.

FIG. 4 shows a flowchart of a method in accordance with one or more embodiments.

FIG. 5 shows a well system utilizing a downhole cladding tool according to embodiments of the present disclosure.

FIG. 6 shows a laser tool in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

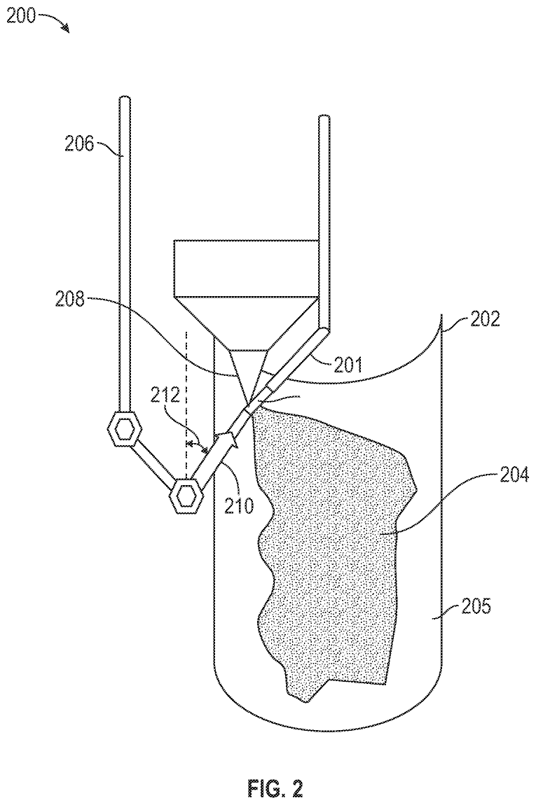

In the following description of FIGS. 2-6, any component described with regard to a figure, in various embodiments disclosed herein, may be equivalent to one or more like-named components described with regard to any other figure. For brevity, descriptions of these components may not be repeated for each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

In one aspect, embodiments disclosed herein relate to an in-situ cladding system which may be configured to perform cladding processes in a downhole or contained and restricted environment. In particular, embodiments disclosed herein relate to a dual head laser which may be employed as a part of an in-situ cladding system. Further, in another aspect, embodiments disclosed herein relate to an in-situ cladding method, which may allow for cladding of a downhole pipe, such as a casing or a tubing, without requiring retrieval or replacement of the pipe.

FIG. 2 shows an in-situ laser cladding system 200 in accordance with one or more embodiments. The in-situ laser cladding system 200 may include a wire feeding system 201 configured to feed a cladding wire 203 onto a target surface 205 of a pipe 202. In one or more embodiments, the target surface 205 may be located on an interior of the pipe 202. The target surface 205 may have a defected area 204 caused by corrosion, rusting, or erosion. The defected area 204 may be, for example, a cavity created in an interior wall of the pipe 202. In one or more embodiments, the cladding wire 203 may be composed of a super alloy, such as Inconel.

The in-situ laser cladding system 200 may also include a dual head laser 206 aimed at the target surface 205, where the dual head laser 206 includes a primary laser beam 208 and a secondary laser beam 210. The pipe 202 may be located in a downhole environment, and both of the wire feeding system 201 and the dual head laser 206 may be provided in the downhole environment such that cladding is performed in-situ, with no need for retrieval of the pipe 202.

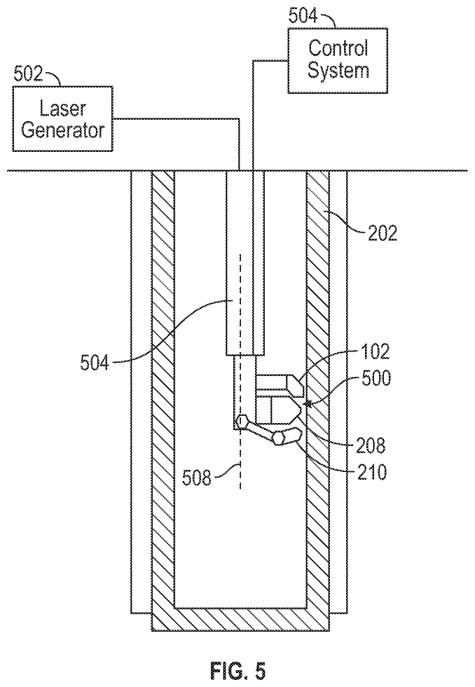

In one or more embodiments, the wire feeding system 201 and the dual head laser 206 may be provided as a single downhole cladding tool 500, shown in FIG. 5, which may be connected at the end of a line 504, e.g., coiled tubing or a drill string, and lowered into tubing or casing in a well to the selected downhole location. In some embodiments, the cladding tool may include a connector to connect the cladding tool to a coiled tubing string. The coiled tubing string may be used for moving the cladding tool through the wellbore.

In some embodiments, a camera may be disposed on the cladding tool to capture images or video during operation of the cladding tool to assure the cladding is applied to the target surface 205. For example, an acoustic camera may be used to image the target surface 205 precisely in cases where unclear media (such as water or mud) may be present in the downhole environment. Alternatively, a downhole camera may be used to image the target surface 205.

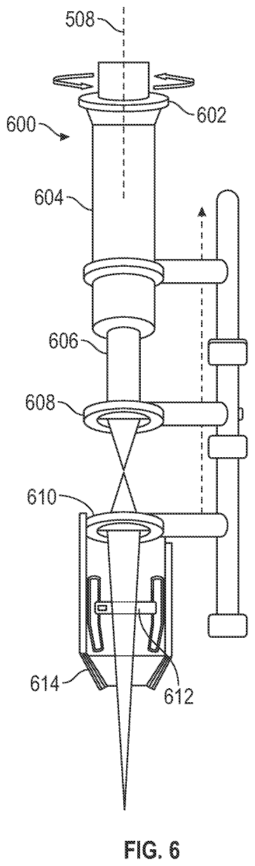

The dual head laser 206 may be secured to the coiled tubing string via a rotational device 602, shown in FIG. 6, which may allow the dual head laser 206 to rotate 360º about an axis of rotation 508. Each of the primary laser 208 and the secondary laser 210 may include the components of laser 600 shown in FIG. 6, where the primary and secondary lasers 208, 210 may be oriented to direct laser beams in different radially outward directions from the axis of rotation 508, as shown best in FIG. 5. An insulation cable 604 may extend from the rotational device 602. In one or more embodiments, the insulation cable 604 may be rated for high pressures and high temperatures, such as those typically present in downhole environments. The insulation cable 604 may be, for example, a fiber optic cable. A laser beam 606 may exit the insulation cable 604 and may be directed towards a focused lens 608 and a collimation lens 610, which may be configured to shape and size the laser beam 606 according to its intended purpose.

One or more cover lenses 612 may be arranged perpendicular to the laser beam 606. In one or more embodiments, the one or more cover lenses 612 may be configured to protect the focused lens 608, the collimation lens 610, and the optical fiber from back reflection, dust, and debris. One or more purging nozzles 614 may be positioned at an exit of the laser 600 and may be configured to clear a path for the laser beam 606 emitted from the laser 600. More specifically, the one or more purging nozzles 614 may clear any debris from the path of the laser beam 606.

A laser generator 502, shown in FIG. 5, may be connected to the cladding tool, where the laser generator 502 may generate and provide lasers for the primary and secondary lasers. In one or more embodiments, the laser generator 502 may be provided at the surface of a well, where the laser beams may be transported downhole to the cladding tool using an optical transmission medium such as a fiber optic cable, which may be packaged with other power cables in a single line 504. In some embodiments, the laser generator 502 may be located downhole and connected to the cladding tool. An example generator is a direct diode laser. The optical power of the primary and secondary laser beam may be within a range of 0.2 kilowatts (kW) to 100 KW. For example, the optical power of the laser beam may be greater than 0.2 and up to 10 kW.

A control system 506 may be in communication with the cladding tool to control movement of at least part of the cladding tool, e.g., to cause the primary and secondary laser beams to move and to rotate within the wellbore and to dispense cladding wire. For example, the control system 506 may include a computing system. The cladding tool may be moved downhole via the coiled tubing unit or wireline. The movement may be computer-controlled or may be controlled manually. Movement of the cladding tool downhole may be controlled by sending commands from the computing system to the cladding tool when the cladding tool is positioned downhole, e.g., via the coiled tubing unit or wireline. For example, using the control system 506, the downhole cladding tool 500 may be moved axially through the pipe 202 and rotationally within the pipe 202 in sequential incremental movements in order to apply and weld together adjacent and sequential lines of wire feed to a target surface 205 of the pipe 202.

The dual head laser 206 may have a primary laser beam 208 which may be aimed at the target surface 205 in a direction normal to the target surface 205. The primary laser beam 208 may be configured to melt the cladding wire 203 onto the target surface 205. The dual head laser 206 may also have a secondary laser beam 210 aimed at the cladding wire 203 at an angle 212. In one or more embodiments, the angle 212 may range from 20° to 160° relative an axis parallel with the central axis of the pipe 202. The secondary laser beam 210 may include an internal purging system (such as internal purging system 110) configured to blow a gas onto the cladding wire 203.

The purging system 110, as one skilled in the art will be aware, may include a purging medium supplied to an integrator via purge inputs. The integrator may have a cavity, which is configured to receive the purging medium and to encourage turbulent flow of the purging medium. Further, the integrator may combine a laser beam produced by a laser head with the purging medium to produce an outlet which may feed into a conduit. In accordance with one or more embodiments, the conduit may receive the combined laser beam and purging medium in a turbulent state and convert the turbulent flow into a laminar flow. Once the combined laser beam and purging media (in a laminar flow state) exits the conduit and is directed at a target surface 205, the laminar flow may direct the cladding wire 203 in the desired melting direction to form a first layer.

Once the first layer has been formed, the primary laser beam 208 may force the cladding wire 203 in a second melting direction to form a second layer, where the second layer is adjacent and substantially parallel to the first layer. In one or more embodiments, the first melting direction may be directly opposite. For example, the first melting direction may refer to forming a layer from left to right, and the second melting direction may refer to forming a layer from right to left. The purging system 110 may also be used to force the melting of the first layer and the second layer together when the secondary laser beam 210 is activated. The purging system 110 may include a number of different sets of purging nozzles, each set configured to perform a different operation. For example, one set of purging nozzles may be positioned inside the laser head to cool the lenses. Another set of purging nozzles, such as the purging nozzles 614 shown in FIG. 6, may be positioned on the exterior of the laser head to prevent debris from entering the tool and blocked the lenses, as well as to direct the cladding wires.

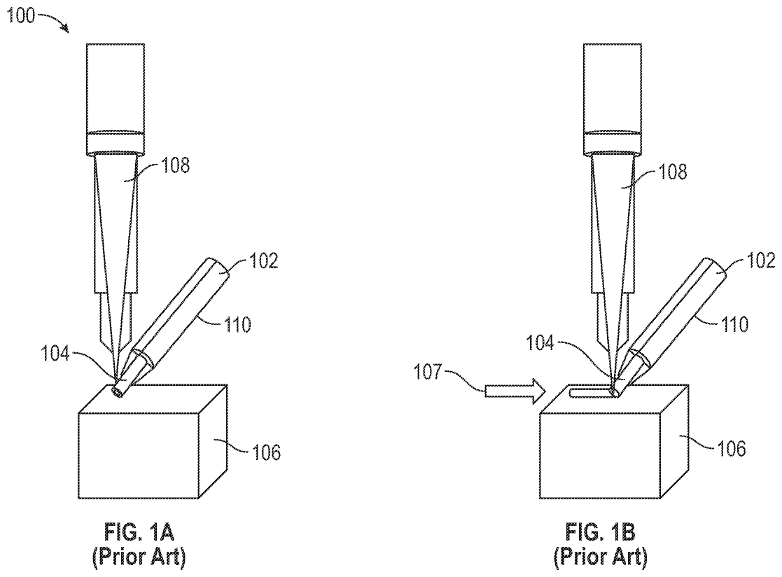

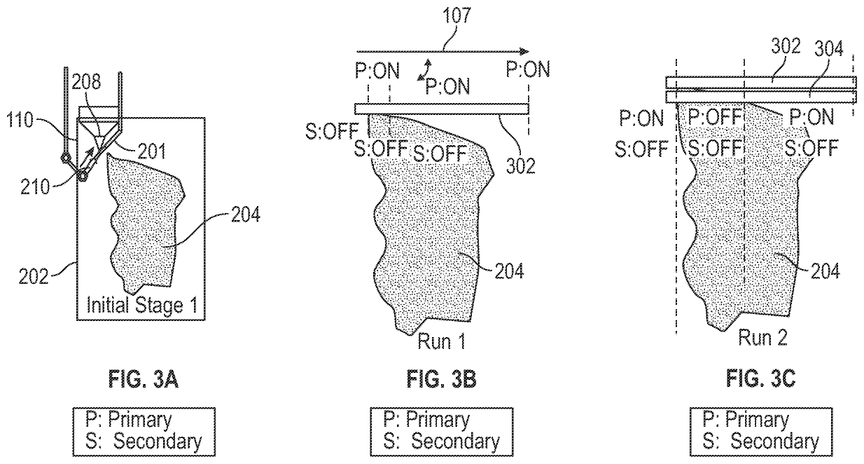

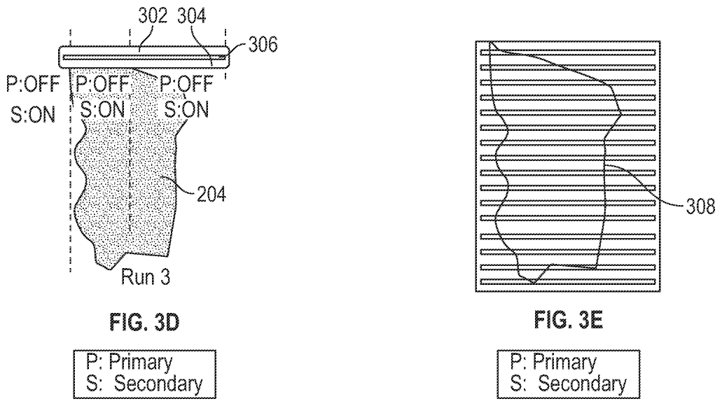

FIGS. 3A-3E show a workflow of using an in-situ laser cladding system 200 in accordance with one or more embodiments. More specifically, each of FIGS. 3A-3E show a stage of the workflow of performing an in-situ laser cladding process on a pipe 202. In a first step of the workflow, as shown in FIG. 1A, the in-situ laser cladding system 200 may be provided at the pipe 202, where the pipe 202 is installed at a downhole location. The pipe 202 may have a defected area 204, which may be a cavity in the wall of the pipe 202.

Turning now to FIG. 3B, the dual head laser 206 may be configured such that the primary laser beam 208 is switched on and the secondary laser beam 210 is switched off. The wire feeding system 201 may feed a cladding wire 203 onto the target surface 205. Further, the primary laser beam 208 may melt the cladding wire 203 onto the target surface 205 in a first layer 302. The wire feeding system 201 and the dual head laser 206 may move across the target surface 205 in a desired direction 107.

Once the in-situ laser cladding system 200 has completed the first layer 302 of melted cladding wire 203, the in-situ laser cladding system 200 may move such that a second layer 304 is started, as shown in FIG. 3C. The second layer 304 may be formed in the same manner as the first layer 302.

The in-situ cladding system 200 may be configured to detect a beginning of the defected area 204 formed on the target surface 205. For example, scanning and imaging technology can be used to identify target surface 205. Specifically, a 3D imaging tool may be run downhole and may be configured to generate 3D images of the downhole environment, including areas of weakened integrity, such as the target surface 205, in downhole pipes. The primary laser beam 208 may be switched on and switched off manually, where the images produced by the 3D imaging tool are monitored by an operator at the surface and where the operator activates and deactivates the primary laser beam 208 based on those images. Alternatively, the primary laser beam 208 may be operated autonomously, where the 3D imaging tool produces live feedback images and a controller may turn on or turn off the primary laser beam 208 based on the live feedback images. In one or more embodiments, the controller may utilize artificial intelligence to analyze the images and to control the activation and deactivation operations of the primary laser beam 208.

Once the beginning of the defected area 204 is detected, the primary laser beam 208 may be switched off and the wire feeding system 201 may continue to feed wire across the defected area 204. The in-situ cladding system 200 may also detect an ending edge of the defected area 204, such that once the system 200 passes the ending edge, the primary laser beam 208 may be switched on and may resume melting the cladding wire 203 onto the target surface 205 to finish the second layer 304.

Once the first layer 302 and the second layer 304 are complete, the primary laser beam 208 may be switched off and the secondary laser beam 210 may be switched on. The secondary laser beam 210 may be configured to weld together the first layer 302 and the second layer 304, such that a welded layer 306 may overlap both the first layer 302 and the second layer 304, as shown in FIG. 3D. The purging system 110 may configured to force the weld to properly overlap the first layer 302 and the second layer 304. Once the welding process is completed, the secondary laser beam 210 may be switched off and the primary laser beam 208 may be switched on to melt a third layer of cladding wire 203 onto the target surface 205. The process shown in FIGS. 3B-3D may be repeated until the entirety of the defected area 204 is cladded, producing a cladded surface 308 as shown in FIG. 3E.

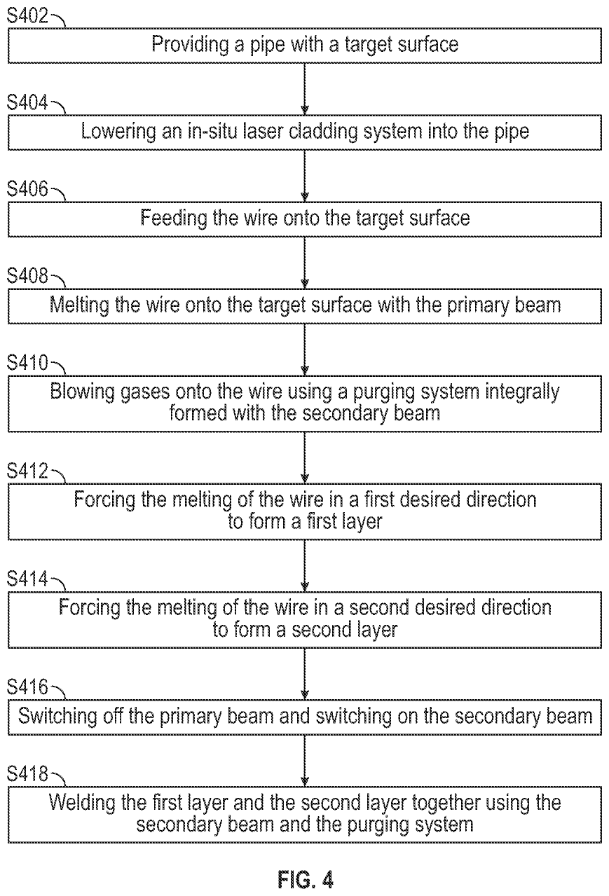

FIG. 4 shows a flowchart for a method of logging while levitating in accordance with one or more embodiments. More specifically, FIG. 4 depicts a flowchart 400 of a method for performing an in-situ cladding process in accordance with one or more embodiments. Further, one or more blocks in FIG. 4 may be performed by one or more components as described in FIGS. 2-3E. While the various blocks in FIG. 4 are presented and described sequentially, one of ordinary skill in the art will appreciate that some or all of the blocks may be executed in different orders, may be combined, may be omitted, and some or all of the blocks may be executed in parallel. Furthermore, the blocks may be performed actively or passively.

Initially, a pipe 202 may be provided, where the pipe 202 has a target surface 106. S402. In one or more embodiments, the pipe 202 may be provided in a downhole environment. In other embodiments, the pipe 202 may be provided in a contained and restricted area. The target surface 205 may include a defected area 204, which may be caused by corrosion, rusting, or erosion. In one or more embodiments, the defected area 204 may be a cavity. In one or more embodiments, the target surface 205 may be an interior surface inside of a pipe.

An in-situ laser cladding system 200 may be lowered into an interior of the pipe 202, S404. The in-situ laser cladding system 200 may include a dual head laser 206 and a wire feeding system 201. The dual head laser 206 may include a primary laser beam 208 positioned so that the laser beam is positioned vertically above at a cladding wire 203 dispensed by the wire feeding system 201. The dual head laser 206 may also include a secondary laser beam 210 directed onto the cladding wire 203 at an angle.

The cladding wire 203 may be fed onto the target surface 205 using the wire feeding system 201, S406. In one or more embodiments, the cladding wire 203 may be composed of a super alloy, such as Inconel. Using the primary laser beam 208, the cladding wire 203 may be melted onto the target surface 205, S408, while leaving any portion of the cladding wire covering the defected area un-melted. In particular, the cladding wire 203 may be applied onto the target surface 205 in a first layer 302. The primary laser beam 208 may be positioned directly over the cladding wire being applied to melt and weld the cladding wire to a surface. Because a defected area, such as a cavity, may not have a surface on which to weld, the primary laser beam 208 may be off as the laser head moves over the defected area.

Using an internal purging system 110 integrally formed with the secondary laser beam 210, a process gas may be blown onto the cladding wire 203, S410. The process gas may be, for example, nitrogen, argon, or helium. The melting of the cladding wire 203 may be forced in a first desired direction to form a first layer 302 by movement of the in-situ cladding system 200, S412. Further, the melting of the cladding wire 203 may be forced in a second desired direction to form a second layer 304, S414. In one or more embodiments, the first desired direction and the second desired direction may be opposite to one another. In other embodiments, the first desired direction and the second desired direction may be the same.

Once the first layer 302 and the second layer 304 have been formed, the primary laser beam 208 may be switched off and the secondary laser beam 210 may be switched on, S416. The first layer 302 and the second layer 304 may then be welded together using the secondary laser beam 210 and the purging system 110, S418. In contrast to the primary laser beam, the secondary laser beam 210 may be angled, which allows its contact with the top of an applied cladding wire layer in order to melt the top of the cladding wire and weld it to another adjacent cladding layer. In such manner, the portions of cladding wire layers that were not welded to a surface using the primary laser beam may be welded together using the secondary laser beam. The method steps described above may be repeated until the entirety of the defected area 204 of the target surface 106 is cladded.

In one or more embodiments, the method may further include detecting a beginning of the defected area 204 formed on the target surface 106 using a 3D imaging tool. Once the beginning of the defected area 204 is detected, the primary laser beam 208 may be switched off and the wire feeding system 102 may continue to feed wire across the defected area 204. The in-situ cladding system 200 may also detect an ending edge of the defected area 204, such that once the system 200 passes the ending edge, the primary laser beam 208 may be switched on and may resume melting the cladding wire 104 onto the target surface 106 to finish the second layer 304.

Embodiments of the present disclosure may provide at least one of the following advantages. Cladding of downhole pipes, such as casings and tubulars, currently requires retrieval of the pipe from its downhole environment. Further, in many instances, such as those where a cavity has formed in the pipe, replacement of the pipe section is required. Embodiments of the present disclosure allow for in-situ cladding of the pipe, negating the need to remove the pipe from its downhole environment. Further, the present disclosure allows for cladding over a cavity in the pipe, removing the need for replacement of the pipe.

Present laser cladding solutions include only one laser head, requiring repositioning in order to weld together cladded layers. Embodiments of the present disclosure include a dual head laser, where the primary laser beam is directly aimed at the cladding wire, and the secondary laser beam is directed onto the cladding wire at an angle. Such a configuration ensures increased efficiency by eliminating the need to reposition the laser between producing cladding layers and welding together layers.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. An in-situ cladding method, comprising:
providing a pipe with a target surface,
wherein the target surface comprises a defected area;
lowering an in-situ cladding system into the pipe,
wherein the in-situ cladding system comprises a dual head laser and a wire feeding system,
wherein the dual head laser comprises a primary beam and a secondary beam;
lowering the wire feeding system into the pipe;
feeding a cladding wire onto the target surface;
melting the cladding wire onto the target surface with the primary beam;
blowing gas onto the cladding wire using a purging system integrally formed with the secondary beam;
forcing melting of the cladding wire in a first desired direction to form a first layer;
forcing melting of the cladding wire in a second desired direction to form a second layer;
switching off the primary beam and switching on the secondary beam; and
welding the first layer and the second layer together using the secondary beam and the purging system.

2. The in-situ cladding method of claim 1, wherein the method is repeated for a plurality of layers such that an entirety of the defected area is cladded.

3. The in-situ cladding method of claim 1, further comprising:
detecting a beginning of a cavity of the defected area;
switching off the primary beam;
feeding the cladding wire across the cavity;
detecting an end of the cavity and a beginning of the target surface;
switching on the primary beam; and
melting the cladding wire onto the target surface with the primary beam.

4. The in-situ cladding method of claim 1, wherein the primary beam is directed onto the cladding wire in a direction normal to the target surface.

5. The in-situ cladding method of claim 1, wherein the secondary beam is directed onto the cladding wire at an angle relative to an axis parallel with a central axis of the pipe.

6. The in-situ cladding method of claim 5, wherein the angle ranges from 20° to 160°.

7. The in-situ cladding method of claim 1, wherein the cladding wire is composed of a super alloy.

8. The in-situ cladding method of claim 7, wherein the cladding wire is composed of Inconel.

9. The in-situ cladding method of claim 1, further comprising providing the pipe in a downhole environment or a contained and restricted area.

10. An in-situ cladding system, comprising:
a wire feeding system configured to feed a cladding wire onto a target surface of a pipe; and
a dual head laser aimed at the target surface.

11. The in-situ cladding system of claim 10, wherein the dual head laser comprises:
a primary laser beam aimed at the target surface; and
a secondary laser beam aimed at the cladding wire at an angle relative to an axis parallel with a central axis of the pipe.

12. The in-situ cladding system of claim 11, wherein the primary laser beam is configured to melt the cladding wire onto the target surface.

13. The in-situ cladding system of claim 11, wherein the secondary laser beam comprises an internal purging system configured to blow a gas onto the cladding wire.

14. The in-situ cladding system of claim 11, wherein the angle ranges from 20° to 160°.

15. The in-situ cladding system of claim 10, wherein the cladding wire is composed of a super alloy.

16. The in-situ cladding system of claim 15, wherein the cladding wire is composed of Inconel.

17. The in-situ cladding system of claim 10, wherein the target surface is defected such that a cavity is created in the target surface.

18. The in-situ cladding system of claim 17, wherein the cavity is created by corrosion of the pipe.

19. The in-situ cladding system of claim 11, wherein the primary laser beam is configured to melt layers of the cladding wire onto the target surface.

20. The in-situ cladding system of claim 19, wherein the secondary laser beam is configured to weld together adjacent layers of the cladding wire which have been melted onto the target surface.
